(19) United States
(12) Patent Application Publication
(10) Pub. No.: US 2006/0081174 A1
(43) Pub. Date: Apr. 20, 2006

(54) Vacuum nozzle for spray system

(75) Inventor: Zygmunt Baran, Windsor (CA)

Correspondence Address: CARLSON, GASKEY & OLDS, P.C., 400 WEST MAPLE ROAD, SUITE 350, BIRMINGHAM, MI, 48009, US

(73) Assignee: Doben Limited

(21) Appl. No.: 11/023,239

(22) Filed: Dec. 27, 2004

Related U.S. Application Data
(60) Provisional application No. 60/619,086, filed on Oct. 15, 2004.

(51) Int. Cl. B05B 15/12; B05B 15/04; B05C 5/00

(52) U.S. Cl. 118/50; 118/326

(57) ABSTRACT

A cold spray system includes a spray nozzle for depositing material onto a substrate. A collection assembly at least partially surrounds the spray nozzle for vacuuming undepositive material and gases in the work area. The collection assembly includes a transparent collection tube at an end portion of the collection assembly to provide visibility to the work area. The collection assembly includes a shield having a flange that extends radially outwardly from the collection assembly and is generally parallel to a substrate. An angled portion of the shield extends from the collection assembly. A radius portion adjoins the flange and the angled portion. A ring is spaced between the spray nozzle and the shield. An inner surface of the ring deflects material that typically would otherwise not become adhered to the substrate back into the collection assembly to minimize the material that must be vacuumed at the substrate. A curved surface of the ring extends from a surface spaced from the substrate toward the shield to provide a smooth transition for materials flowing along the substrate back into the collection assembly.

The present application claims priority to U.S. Provisional Patent Application Ser. No. 60/619,086, filed Oct. 15, 2004.

### BACKGROUND OF THE INVENTION

This invention relates to a vacuum nozzle for a cold spray system.

Cold spray systems are used to adhere materials to a substrate by flowing the material through a nozzle at supersonic speeds. The material becomes deformed and adheres to the substrate upon impact. Specifically, the material is entrained in a carrier gas. The material laden carrier gas is drawn into a supersonic flow compressed gas and is accelerated as it travels through an expanding nozzle.

A portion of the material does not adhere to the substrate. In the case of using the system to abrade the substrate, similar to a media blaster, none of the material adheres to the substrate. In both cases, it is desirable to collect loose material in addition to the carrier and compressed gases. To this end, a collection system is used to vacuum any loose material and gases in the work area.

It is desirable to provide a cold spray system that is portable for such applications as auto body panel repairs. These repair processes are preferably conducted with minimal disturbance and contamination of the work environment normally associated with such repairs. Therefore, it is desirable to provide a cold spray system that is portable by providing efficient collection of the material and gases.

### SUMMARY OF THE INVENTION

The inventive material spray system includes a spray nozzle for depositing material onto a substrate. A collection assembly at least partially surrounds the spray nozzle for vacuuming undeposited material and gases in the work area. In one example embodiment, the collection assembly includes a transparent collection tube at an end portion of the collection assembly to provide visibility to the work area, which is especially useful for handheld process applicators.

To provide more efficient collection of the undeposited material and gas in the work area, a shield at the end portion of the collection assembly is arranged to more efficiently draw air into the collection assembly. In one example, the shield includes a flange that extends radially outwardly from the collection assembly and is generally parallel to the substrate. An angled portion of the shield extends from the collection assembly. A radius portion adjoins the flange and the angled portion. The profile of the inner surface of the shield provides a smooth transition for air entering the collection assembly to minimize turbulent flow of the air into the collection assembly, which would reduce the efficiency of the vacuum.

The inventive collection assembly also includes a consumable ring at the end portion of the collection assembly. The ring is spaced between the spray nozzle and the shield. An inner surface of the ring deflects material that typically would otherwise not become adhered to the substrate back into the collection assembly to minimize the material that must be vacuumed at the substrate. A curved surface of the ring extends from a surface spaced from the substrate toward the shield to provide a smooth transition for materials flowing along the substrate back into the collection assembly. The curved surface of the ring minimizes turbulent flow from the substrate back into the collection assembly.

Accordingly, the present invention provides a cold spray system that is compact by providing efficient collection of the material and gases.

These and other features of the present invention can be best understood from the following specification and drawings, the following of which is a brief description.

### BRIEF DESCRIPTION OF THE DRAWINGS

FIG. 1 is a schematic view of an example cold spray system.

FIG. 2 is a cross-sectional view of one example embodiment of the inventive material spray nozzle and collection assembly.

### DETAILED DESCRIPTION OF THE PREFERRED EMBODIMENT

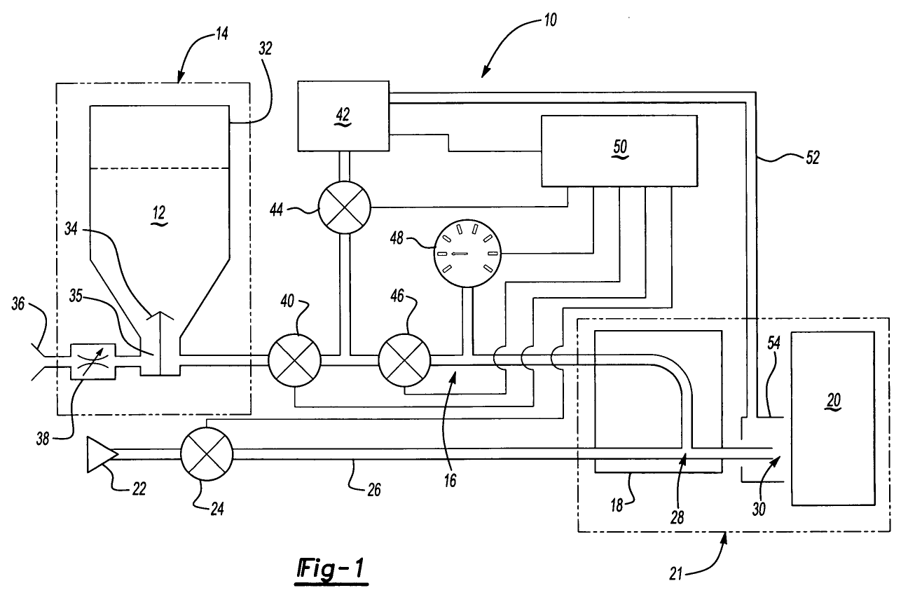

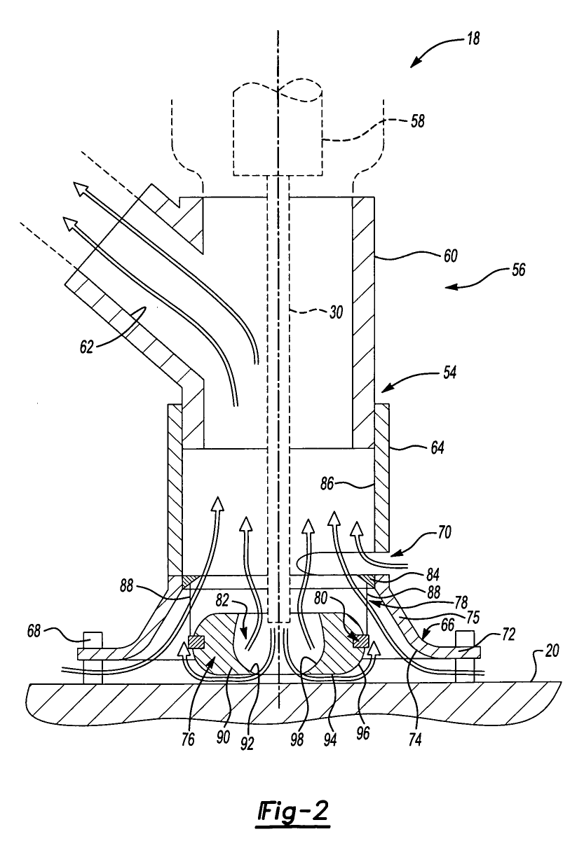

An example cold spray system 10 is schematically shown in FIG. 1. The system 10 deposits material 12 provided by a power feeder 14 through a feed line 16. The material 12 is directed onto a substrate 20 using a process applicator 18. The process applicator 18 includes a handheld unit 54 (shown in FIG. 2) used in a work area 21 to deposit materials at supersonic speeds onto a substrate 20, such as an automotive body panel.

A propulsion gas supply 22 provides a compressed gas, for example at a pressure of between 60 and 100 psi, to create supersonic velocities of the material exiting the process applicator 18. The compressed gas flows from the propulsion gas supply 22 through a gas valve 24 along a pressure line 26 to an intersection 28 in the process applicator 18. Material 12 flowing through the feed line 16 is introduced to the compressed gas at the intersection 28. The pressure line 26 pulls a vacuum on the feed line 16. A venturi (not shown) is arranged upstream of a spray nozzle 30, for example near the process applicator 18, to achieve supersonic speeds of the material 12.

The power feeder 14 includes a hopper 32 containing the material 12. The material 12 may be a substance suitable for cold spray applications, as is known in the art. The material 12 may be a mixture of abrasive substances and substances suitable for adhering to the substrate 20. Moreover, multiple hoppers may be used to introduce different materials. A gate valve 34 is opened to permit material 12 to flow into a mixing chamber 35 in which the material 12 becomes entrained in a carrier gas. The carrier gas, which may be atmospheric air, enters the power feeder 14 through a carrier gas inlet 36. The flow rate of carrier gas through the power feeder 14 is controlled by a flow control 38. The material laden carrier gas flows through a power feed valve 40 and through a post-vacuum valve 46 to the intersection 28.

A vacuum unit 42 is in fluid communication with the feed line 16. A vacuum valve 44 is arranged between the vacuum unit 42 and the feed line 16 to selectively control the vacuum pulled on the feed line 16. A pressure sensor 48 is in fluid communication with the feed line 16 to monitor the pressure within the feed line 16. The valves 24, 40, 44 and 46 and pressure sensor 48 communicate with a controller 50. The controller also communicates with the vacuum unit 42. Of course, other sensors and components may be employed in the system 10 and monitored and controlled by the controller 50.

A vacuum line 52 fluidly connects the vacuum unit 42 with a collection assembly 54 of the process applicator 18. Typically, less than all of the material 12 is deposited onto the substrate 20. It may be desirable to collect the loose material undeposited, carrier and compress gases from the propulsion gas supply 22. To this end, the collection assembly 54 collects material 12 that has not been deposited onto the substrate 20 along with the carrier and compressed gases.

Referring to FIG. 2, an inventive collection assembly 54 is shown. The spray nozzle 30 and collection assembly 54 may be packaged to provide a compact hand-held unit 56. Of course, one of ordinary skill should understand that the inventive collection assembly 54 need not be portable to fall within the scope of the claims.

The collection assembly 54 provides a vacuum chamber. The spray nozzle 30 is supported by the nozzle holder 58. The nozzle 30 extends within an interior cavity of a vacuum adaptor 60. The vacuum adaptor 60 includes a fluid exit 62 that is in fluid communication with the vacuum line 52. The collection assembly 54 includes a collection tube 64 that is supported by the vacuum adaptor 60. In one example, the collection tube 64 is translucent or transparent to provide the operator of the hand-held unit 56 better visibility of the work area 21, and more specifically, to see the material 12 being deposited on the substrate 20 so that the operator can make adjustments as needed.

The collection assembly 54 includes a shield 66 near the collection tube 64. The shield 66 includes one or more stand-offs 68 that are adjustable to provide a desired spacing between the hand-held unit 56 and the substrate 20. The assembly 54 includes an opening 70 in the collection tube 64 to permit surrounding air to flow into the collection assembly 54. A curtain of surrounding air passing from the opening 70 over the inside surface of the collection tube 86 acts to minimize adherence of dust and other contamination which would otherwise impair the visibility of the process. One or more openings 70 may be arranged around the circumference of the collection tube 64.

The shield 66 includes a flange 72 extending radially outward relative to the collection tube 64. In the example shown, the flange 72 is annular in shape and supports the stand-offs 68. A radius portion 74 adjoins the flange 72 and an angled portion 75, which is supported near the collection tube 64. The radius portion 74 better ensures that air flowing into the assembly between the shield 66 and the substrate 20 does not generate an undesired amount of turbulence. That is, the radius portion 74 better ensures laminar flow along the shield 66 to avoid turbulence. A deflector ring 84 extends radially inwardly relative to the shield 66 and collection tube 64. The deflector ring 84 prevents collected material 12 from abrading an inner surface 86 of the collector tube 64, which would hamper the view of the operator over time.

A ring 76 is supported within the collection assembly 54 by a bracket 78. The ring 76 is a consumable component of the hand-held unit 56, and is removably secured to the bracket 78 by a retainer 80. The ring 76 is constructed out of silicone in one example. The ring 76 includes a central aperture 82 having an inwardly extending protrusion 90 providing an apex 92 when shown in cross-section in the example embodiment. An area around the apex 92 may be reinforced to resist wear, for example, with a ceramic. The protrusion provides an inwardly extending portion of the ring 76 adjacent to the substrate 20 at an end of the hand-held unit 56. The ring 76 provides a first surface 94 that runs generally parallel to the substrate 20. The ring 76 includes a second surface 98 that has a curvature, in the example shown. The second surface 98 extends to the apex 92 providing the protrusion 90. A curved surface 96 adjoins the first surface 94 and provides a profile that encourages laminar flow along the exterior of the ring 76 to create a Coanda effect.

In operation, material exits the nozzle 30 at supersonic speeds for deposit onto the substrate 20. The material 12 exits the nozzle 30 in a diverging pattern. Material at the extremity of the spray pattern is deflected off of the second surface 98 and is directed to the vacuum adaptor 60 through the collection tube 64. The material 12 deflected by the second surface 98 typically resulted in material that did not become deposited on the substrate 20. In this manner, the loose material that must be collected on the substrate is reduced, which increases collection efficiency. Material flowing through the aperture 82 that does not become deposited on the substrate 20 flows through the gap between the ring 76 and substrate 20. The material entrained gas flows along the first surface 94 and curved surface 96 without creating an excess amount of turbulence. A Coanda effect provides increased flow at the substrate 20. Surrounding air is drawn into the collection assembly 54 between the shield 66 and substrate 20. The air entering the collection assembly generally maintains laminar flow in to the collection assembly 54 since a gradual radius is provided between the flange 72 and angle portion 75.

The inventive collection assembly 54 provides a compact process applicator since the material 12 is collected more efficiently. The shield shape better ensures that surrounding air is drawn into the collection assembly 54 more efficiently. The ring 76 provides more efficient collection of the material 12 by deflecting material 12 that would likely not otherwise be deposited on the substrate 20 back into the collection tube and by efficiently drawing undeposited material from the substrate 20 back into the collection assembly 54.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A material spray system comprising:
a spray nozzle for depositing material; and
a collection assembly proximate to the spray nozzle for vacuuming undeposited material, the collection assembly including a transparent collection tube at least partially surrounding the spray nozzle for visually exposing a work area proximate to the spray nozzle.

2. The system according to claim 1, wherein the collection assembly at least partially surrounds the spray nozzle for providing a vacuum chamber around the spray nozzle.

3. The system according to claim 2, wherein a shield extends from the collection tube at an end portion of the collection assembly, the shield including a radially outwardly extending flange and an angled portion extending from the collection tube, a radius portion adjoining the flange and the angled portion providing a smooth transition between the flange and radius portion.

4. The system according to claim 1, wherein the collection assembly includes a deflector ring proximate to an inner surface of the collection tube for directing air away from the inner surface.

5. The system according to claim 1, wherein the collector tube includes an opening enabling air exterior of the collection assembly to flow into the collection tube.

6. A material spray system comprising:
a spray nozzle for depositing material, the spray nozzle having an exit;
a collection assembly surrounding at least a portion of the spray nozzle for vacuuming undeposited material, the collection assembly including a shield at an end portion of the collection assembly; and
a ring arranged at the end portion spaced radially apart from and proximate to the exit, the ring spaced apart from the shield.

7. The system according to claim 6, wherein the exit is partially disposed within a central aperture of the ring, the aperture provided by a surface extending radially inward for deflecting material away from a work area.

8. The system according to claim 6, wherein the ring includes a first surface arranged transverse to the spray nozzle, the ring having an aperture extending to the first surface, a curved surface adjoining the first surface and extending toward the shield.

9. The system according to claim 8, wherein a second surface defines the aperture, the second surface extending radially inward and toward the first surface.

10. The system according to claim 6, wherein the collection assembly includes a bracket supporting the ring and a retainer removably securing the ring to the bracket, the bracket including a hole permitting air to flow from the shield through the bracket.

11. The system according to claim 6, wherein the shield includes a radially outwardly extending flange and an angled portion extending from the collection tube, a radius portion adjoining the flange and the angled portion providing a smooth transition between the flange and radius portion.

12. A material spray system comprising:
a spray nozzle for depositing material; and
a collection assembly surrounding at least a portion of the spray nozzle for vacuuming undeposited material, the collection assembly including a shield having a radially outwardly extending flange and an angled portion extending outward and away from the spray nozzle toward the flange, a radius portion adjoining the flange and the angled portion providing a smooth transition between the flange and radius portion.

13. The system according to claim 12, wherein the flange portion supports an adjustable stand-off for setting a spacing between the shield and a substrate.

14. The system according to claim 12, wherein the collection assembly includes a transparent collector tube and the angled portion is arranged proximate to the collector tube.

15. The system according to claim 12, wherein a ring is arranged in the collection assembly and spaced between the spray nozzle and the shield.
